(19) United States
(12) Patent Application Publication
(10) Pub. No.: US 2012/0018467 A1
(43) Pub. Date: Jan. 26, 2012

(54) HARNESS FOR A CHILD CARRIED ON AN ADULT'S SHOULDERS

(76) Inventor: Amedeo Chiappini, Cernusco Sul Naviglio (Milano) (IT)

(21) Appl. No.: 13/259,294

(22) PCT Filed: Nov. 10, 2009
(86) PCT No.: PCT/IT09/00502

§ 371 Date: Sep. 23, 2011

(30) Foreign Application Priority Data
Jun. 12, 2009 (IT) MI2009A001036

(51) Int. Cl. A61G 1/00

(52) U.S. Cl. 224/158

(57) ABSTRACT

A harness for carrying small children on the shoulders of an adult includes a belt of adjustable length worn at groin level fitted with at least one closing buckle, two bands to be wound round the ankles of the child and two chest straps of adjustable length, similar to braces, that join the belt to the two ankle bands. These latter can be fitted with Velcro strips or with straps each with a buckle to adjust the degree of tightening. The chest straps have two sections joined by a buckle to allow for adjustment. The upper end of each chest strap is stitched at the center. The lower end may be of different designs in accordance with the various ways of connecting it to the belt; in one way two sets of stitching are separated by a central spring-catch buckle; another way features connection to a central plate; in yet another, connection is made by snap-closure hooks and rings.

### FIELD OF APPLICATION OF THE INVENTION

The present invention concerns the field of accessories for taking small children outdoors and, in particular, a harness for a child when carried on the shoulders of an adult. For the child, this position means that the upper part of its thighs, towards the buttocks, rest on the adult's shoulders and its legs on the adult's chest, one on each side of the adult's neck. The child is therefore to some extent seated on the shoulders of the adult and can sit up straight or lean against the adult's head and hold onto it.

### REVIEW OF THE KNOWN ART

In the technical field referred to above, for very young babies perambulators are normally used, and pushchairs for those a little older. If the parent wants closer and more intimate contact with the baby but does not want to carry it round for the whole walk, use can be made of baby slings or shoulder bags designed for the purpose. The slings are usually worn on the chest so that a close watch can be kept in the baby; shoulder bags are generally worn on the back but even in front, as preferred. Both slings and bags contain the baby almost completely, to avoid any risk of some sudden movement causing it to fall down, and are therefore most suitable for the very young ones who cannot yet sit up straight.

From the ages of six months onwards, when they can sit up alone, babies may not want to be carried in a shoulder bag in which they are ensconced and cannot see much of the outside world which, at that age, begins to attract them.

All parents like to carry their child on their shoulders, but most of all the children themselves like it; sitting in a pushchair for a long time is boring for a child while, higher up on a parent's shoulders, it can participate and enjoy its surroundings. For the parents, however, this possibility involves some risk, limiting the use of their hands which must be occupied in holding the child's legs for the entire duration of the walk to prevent it from falling backwards off the shoulders.

GB 2098461 A discloses a device for use in supporting a child being carried on the shoulders of an adult. The device comprises two elongated members to lie upright and spaced apart across chest of the wearer, connected at their lowermost regions by a first strap to pass across the small of the back of the wearer, and connected at their uppermost regions by a band of flexible material to pass behind the back of the neck of the wearer to serve as a backrest for the child; rearward movement of the backrest being prevented by the uprights acting as levers on the back strap. Along the uprights two wraps are positioned to the restraint of the legs of the child. A device like that is bulky to wear because of the uprights and the backrest.

U.S. Pat. No. 5,437,402 A discloses another device for use in supporting a child being carried on the shoulders of the wearer. The device comprises: two ankle wraps, each securely holding one of the child's ankles by means; a chest strap having one end connected to both ankle wraps by means of a three via connecting piece; and the other end connected to a clip for securely attaching the connecting element to the front of the waist of the wearer, for example to the belt. Two chest straps my be used in series joined by a buckle. The ankle wraps are padded and provided with two complementary closing strips of VELCRO®. The main defect of such a device is that to make a sort of loop knot around the wearer's neck together with the legs of the child. Should the child fall backwards inadvertently, the trousers' belt together with the clamped chest strap could be drawn up suddenly, so that the uppermost connecting piece pushed against the wearer's throat constitutes a risk of suffocation.

### SUMMARY OF THE INVENTION

Purpose of the present invention is to enable adults who carry a child on their shoulders to maintain full use of their hands during the walk instead of having to be constantly holding the child's legs to keep it upright. To achieve this purpose, subject of the invention is a harness for children carried on the shoulders of adults, said harness comprising:
two bands to fit round the ankles of the child, with padding on the inside;
means for closing the ankle bands;
a belt of adjustable length to be worn round the trunk of the adult situated at groin level, fitted with at least one buckle for closing it;
means for connecting the ankle bands to the belt;
   in which according to the invention,
said connecting means include two chest straps of adjustable length, each having a first end stitched to the belt in a first stitched areas and a second end stitched to a respective ankle band in a second stitched areas, as stated in claim 1.

Further characteristics of the present invention considered innovative are described in the dependent claims.

The width of the belt should be adequate to support a means of connection to the chest straps, the belt itself being situated at groin level. The straps at chest level, similar to braces, are best made in two pieces joined by a buckle to fix both at the desired length.

The closing means of each ankle band include a third strap of adjustable length centrally connected to its ankle band and closable around it by a buckle so that the band can be tightened as required. A less costly form of said means consists of a strip of Velcro at both ends of each ankle band.

In accordance with a first type of realization, the two areas of stitching at the first ends of the two chest straps keeping the straps substantially perpendicular to the belt respectively one at each side of the buckle.
In accordance with a second type of realization, the two stitched areas at the first ends of the two chest straps can be made superimposed or adjacent while keeping the straps substantially oblique to the belt.

The present invention effectively solves the technical problem of safe transport for a child carried on a person's shoulders, as in fact:
thanks to the adequate thickness of the two ankle bands and to the softness of the material used to make them, said bands ensure a firm and prolonged hold on the legs of the child without obstructing circulation of the blood or causing pain;
the two straps extending down the chest of the person shoulder-carrying the child, keep the ankle bands firmly joined to the belt worn round the person's trunk making it impossible for the child to fall off even in the event of there being any sudden movements.

From what has been stated above it is clear that the invention greatly eases the effort of carrying a child on the shoulders, especially as there is no need to use the hands to hold the child's legs.

The harness of the present invention is simple, practical, light in weight and non-bulky, suitable for walks in hilly areas or at the seaside, but also in towns for visiting museums, shows, markets, etc., as an alternative to the sling or shoulder-bag. An accessory that enables parents to carry their children in a natural, convenient and ergonomic manner. The mode of realization is modular, the belt, straps and bands being adjustable in length to suit the various sizes of both adults and children. Harness the child, pick it up, place it on the shoulders and put it down again is an operation that an adult can carry out without any risk whatever, a further advantage being felt in strengthening the relationship between parents and their children at a time when the latter are wanting to be more active and are seeking ways of satisfying their growing curiosity in everything around them.

### SHORT DESCRIPTION OF THE FIGURES

Further purposes and advantages of the present invention will be made clear by the following detailed description of an example of its realization and by the attached drawings provided solely for explanatory reasons and in no way limitative, wherein:

FIG. 1 shows front views of a father carrying a child on his shoulders, the child being held in a harness realized as described in the present invention.

FIGS. 2, 3, 4 show a view in perspective of the buckle connection used on the belt worn at groin level, seen in FIG. 1.

FIG. 5 gives a view in perspective of the rear connection of an ankle band seen in FIG. 1.

FIG. 6 gives a partial view in perspective of the harness in FIG. 1.

FIGS. 7, 8, and 9 show different examples not included in the claims;

FIG. 10 gives a view in perspective of the central area of a belt worn at groin level, like that of FIG. 9.

### DETAILED DESCRIPTION OF A PREFERRED FORM OF THE INVENTION

In the following description, the same elements that appear in different figures may be marked with the same symbols. When describing a figure reference may be made to elements not shown in that figure but in a preceding one. The scale and proportions of the various elements do not necessarily correspond to reality.

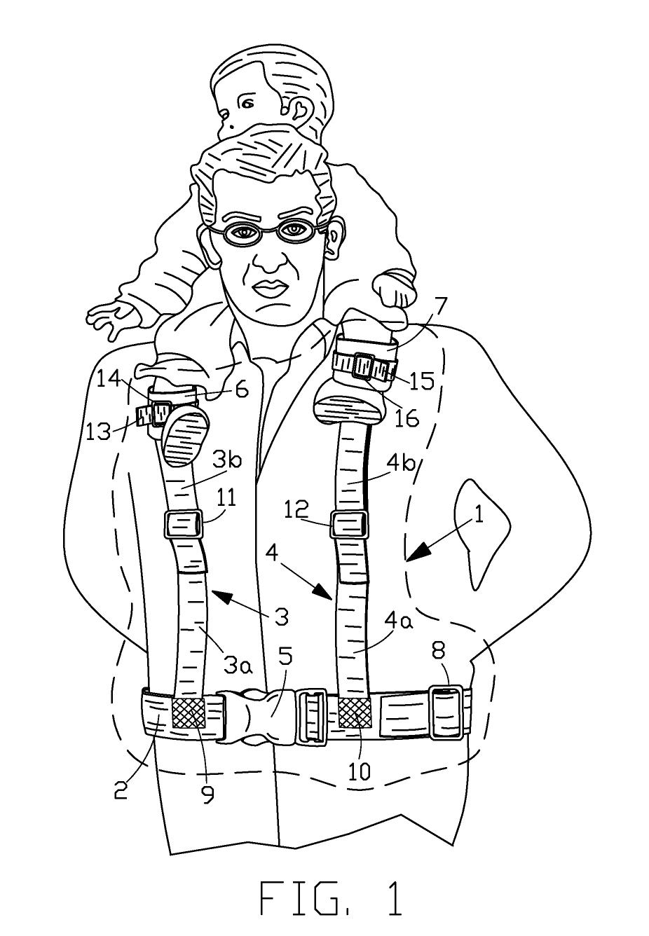

Referring to FIG. 1 an adult is shown carrying a child on his shoulders. Adult and child are united by a harness 1 having a symmetrical configuration suited to the left-right symmetry of the adult. The harness 1 comprises:
a belt 2 placed round the trunk of the adult at groin level;
two straps 3 and 4 that pass upwards from the belt 2 and over the adult's chest like braces, perpendicular to the belt 2, one on each side of a snap-closure buckle 5 in the middle of the belt 2.
two bands 6 and 7 round the legs of the child at ankle level, joined to the upper ends of the straps 3 and 4.

On the belt 2 is a second buckle 8 of a type suitable for adjusting its length. Buckle 8 is situated beyond the point where the strap 4 is joined to the belt 2. The chest straps 3 and 4 are joined to the belt 2 by stitched areas 9 and 10 made at the ends opposite to those fixed to the ankle bands 6 and 7. The stitched areas 9 and 10 cover a rectangular area parallel to the edges of the belt 2. The distance between the centres of stitched areas 9 and 10 is about equal to the distance between the ankles of the child on the adult's shoulders, so that the straps 3 and 4 are kept substantially perpendicular to the belt 2. The strap 3 consists of two sections, 3a and 3b, joined by a buckle 11 that holds them firm and serves for adjusting their overall length. Section 3a is sewn to the belt 2; section 3b is sewn to the ankle band 6. Similarly, the strap 4 is formed of two sections, 4a and 4b, joined by a buckle 12 that holds both sections firm and serves for adjusting their overall length. Section 4a is sewn to the belt 2; section 4b is sewn to the ankle band 7. Ankle band 6 is held firm round one ankle of the child by a small strap 3 fitted with a buckle 14 that is used for adjusting its length and degree of tightness. Similarly, ankle band 7 is held firm round the other ankle of the child by a small strap 15 with a buckle 16 used for adjusting its length and degree of tightness.

The belt 2, chest straps 3 and 4, and the small straps 13 and 15 are made of cloth. For example, the belt 2 can be 1 metre long, 10 centimetres wide and 1 centimetre thick. The chest straps 3 and 4 can be 5 centimetres wide and 0.5 centimetre thick. The ankle bands 6, 7 are made of stratified cloth with padding on the inside. Each band can be 25 centimetres long, 5 centimetres wide and 1 centimetre thick.

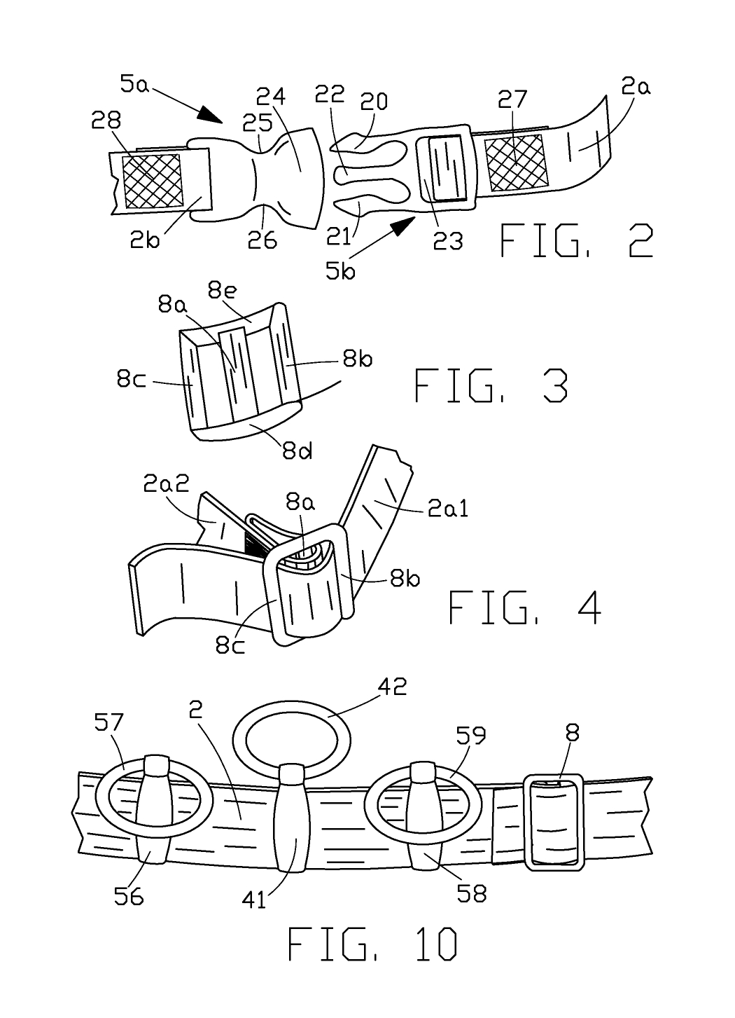

FIG. 2 shows details of the join between the buckle 5 and the belt 2. With reference to FIG. 2, buckle 5 is shown in its open position with its two component parts. Buckle 5 is a “Brunner”-type polypropylene buckle, one frequently used on shoulder packs and for many other applications. It consists of two parts, 5a and 5b, female and male respectively. The male component 5b comprises two lateral elements for flexible insertion, 20 and 21, and a central more rigid guiding element 22. These parts project forward from the remaining frame of the buckle that delimits a ‘window’ 23 into which passes one terminal part 2a of the belt 2, wound round a pin (not seen) fixed to the frame 5b. Terminal part 2a is sewn back onto itself 27 forming a kind of slot round the pin. The female component 5a comprises an internally hollow seat 24 tapering inward to allow entry, with slight pressure, of the flexible elements 20 and 21 when these are sufficiently pressed together guided by the central element 22. In the hollow seat are two apertures, 25 and 26, through which the pointed elements 20 and 21 enter and expand to be held in place by a step in the profile. The buckle 5 is opened by compressing these pointed elements with the fingers of one hand and simultaneously pulling them outwards. In its terminal part component 5a comprises a window through which passes the other terminal 2b of the belt 2, would round a pin (not seen) and sewn back onto itself 28 to form a sort of slot round the pin.

In FIGS. 3, 4, the buckle 8 for adjusting strap length (seen from the back) is formed of a frame comprising two crosspieces, 8e and 8d, two lateral pressure elements, 8b and 8c, inclined inwards, and a central bridge 8a for superimposing the two sections, 2a1 and 2a2, of terminal part 2a. Section 2a2 is sewn back on itself to form a sort of slot round the pin 8a. Section 2a1 passes under the pressure element 8b, over the slot formed by section 2a2 and under the pressure element 8c superimposing itself over section 2a2. Once pulled through as far as required, section 2a1 is held in that position due to pressure from the edges of inclined elements 8b and 8c, as well as by friction.

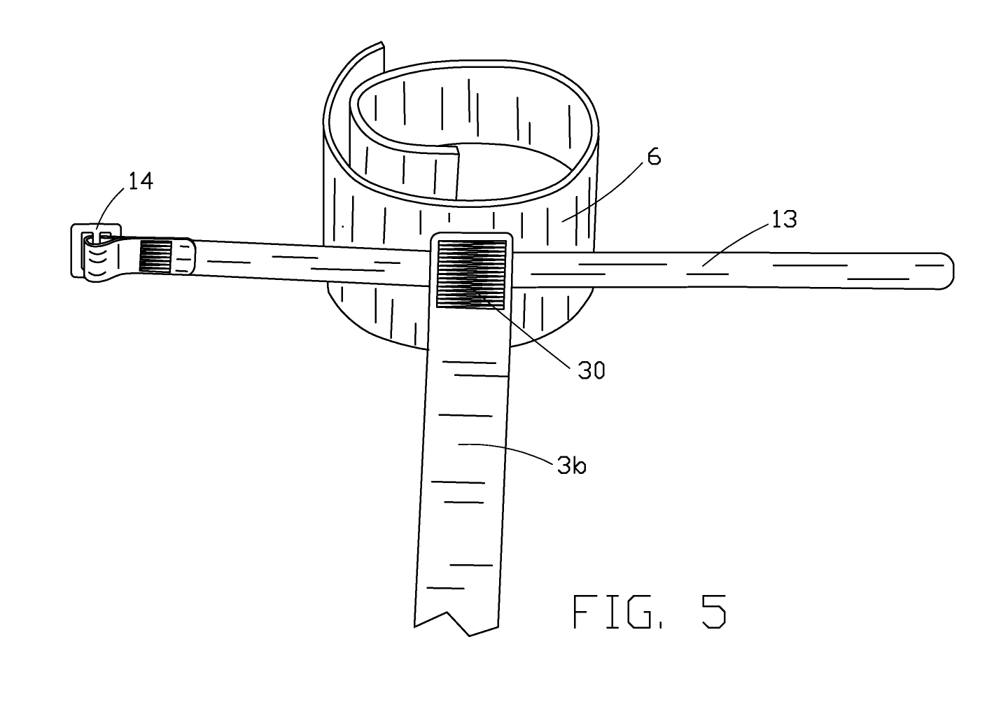

FIG. 5 shows the stitched connection 30 between the ankle band 6, the small strap 13 and the upper end 3b of the chest strap 3. This connection is made by laying the small strap 13 flat over the external side of the ankle band 6, centrally and parallel to it, and superimposing over both of these the terminal part 3b, so that it lies perpendicular to both, then stitching 30 together the three superimposed elements. In this way the band 6 can be fitted round the ankle, independently of the small strap 13 left free for winding round the ankle band 6 to tighten it as required. The small strap 13 is joined to the buckle 14 as previously explained in the case of buckle 8 and belt 2.

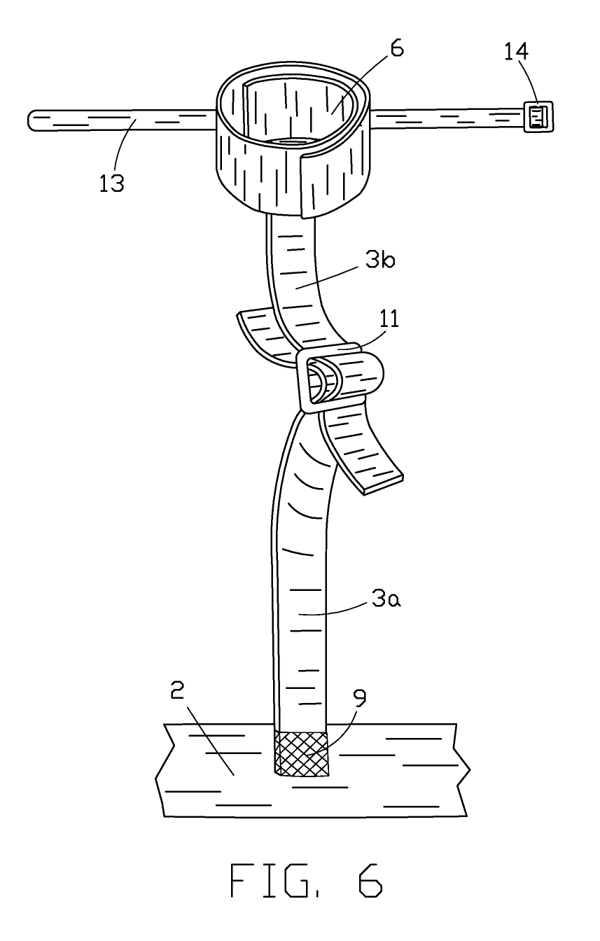

FIG. 6 shows in detail the connection, of adjustable length, between the lower section 3a and the upper section 3b of the chest strap 3 through the buckle 11, this too being of the adjustable type similar to buckle 8. The two sections 3a and 3b pass, one over the other, across the central bridge of buckle 11. The holding device is the ordinary one widely employed for buckles of this type.

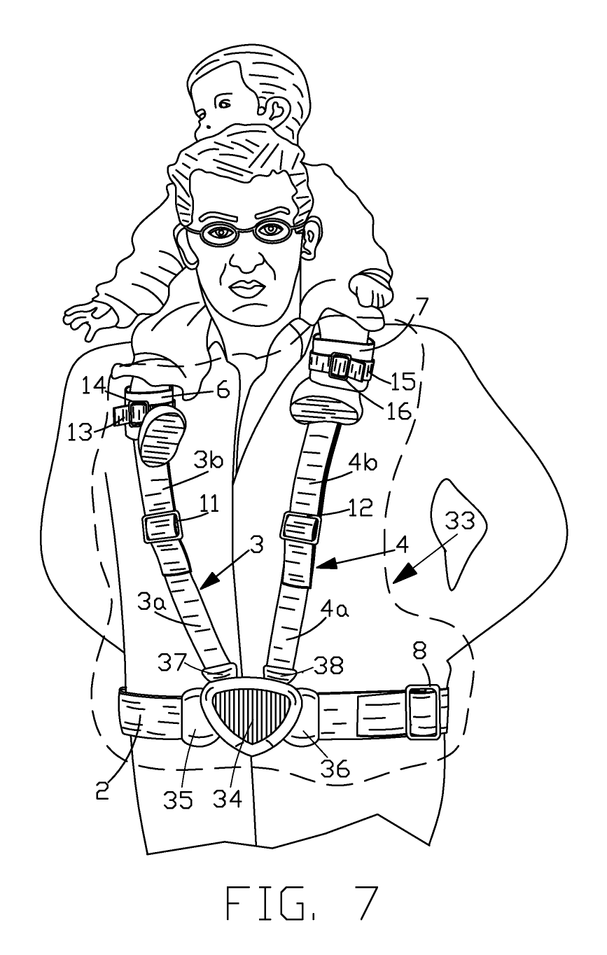

FIG. 7 illustrates a harness 33 that differs from harness 1 chiefly in the different kind of connections between the chest straps 3 and 4, and the belt 2. In particular, the buckle 5 in FIG. 1 is replaced by a heart-shaped plate 34 with four fixing elements, respectively for the ends of sections 3a and 4a and for the ends of the belt 2. The fixing elements for sections 3a and 4a are placed close to one another on the upper and wider part of the plate 34. The fixing elements for the ends of belt 2 are placed one on each side of the plate 34. Straps 3 and 4 converge towards the plate 34 like the two arms of the letter V. The ends of belt 2 are sheathed in their respective housings 35, 36, the ends of sections 3a and 4a being sheathed in their respective shells 37, 38. These shells may be made of polypropylene or of leather and can be permanently fixed to the plate or, if preferred, in such a way that they can be connected and disconnected. The polypropylene shells are glued to their respective belts or straps while the leather shells can be foxed by stitching. The plate 34 can exhibit a personalised design.

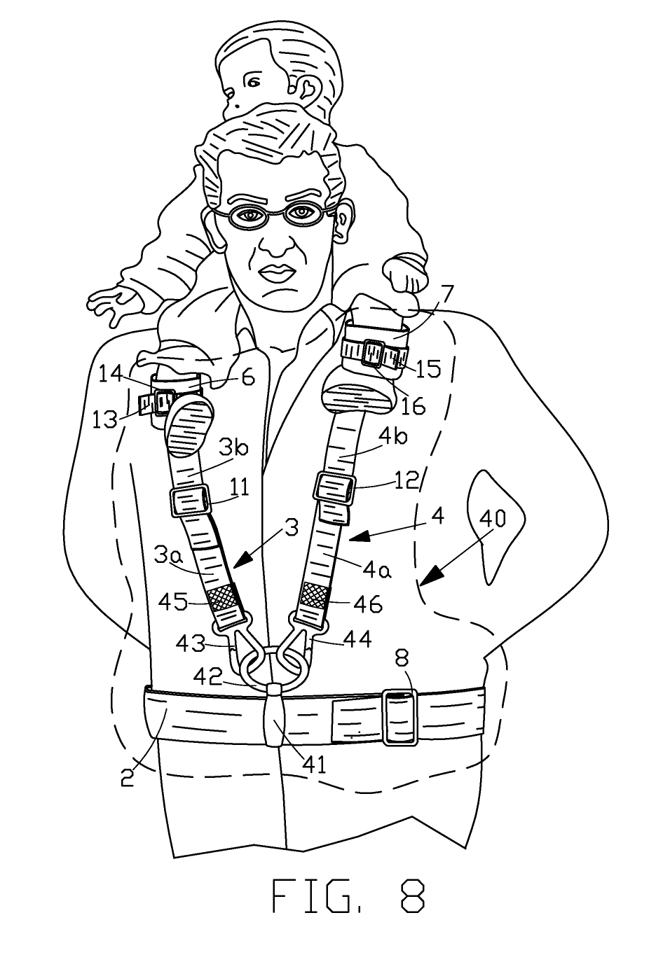

FIG. 8 shows a harness 40 that differs from the harness 1 chiefly because of the different mode of connecting the chest straps 3 and 4 to the belt 2. In particular, the buckle 5 in FIG. 1 is replaced by a support 41 for a ring 42. Support 41 carries a bushing that projects above the upper edge of belt 2; in the bushing there is a round hole for pivotal insertion of ring 42. The end of section 3a is fitted into a cleft in the upper part of a hook 43 of the spring-catch type, said end being folded back on itself to form a sort of slot closed by stitching 45 that holds the end of the strap to hook 43. Similarly, the end of section 4a fits into a cleft in the upper part of a hook 44, of the spring-catch type, said end being folded back on itself to form a sort of slot closed by stitching 46 that holds the end of the strap to hook 44. Both hooks, 43 and 44, close round the ring 42. Contrary to the previous harnesses 1 and 33, the presence of the support 41 avoids any break in the belt 2 at the position of buckle 5 or of plate 34 as said support can be made to suit requirements. In the case of harness 40 the two chest straps 3 and 4 are placed so as to form a V.

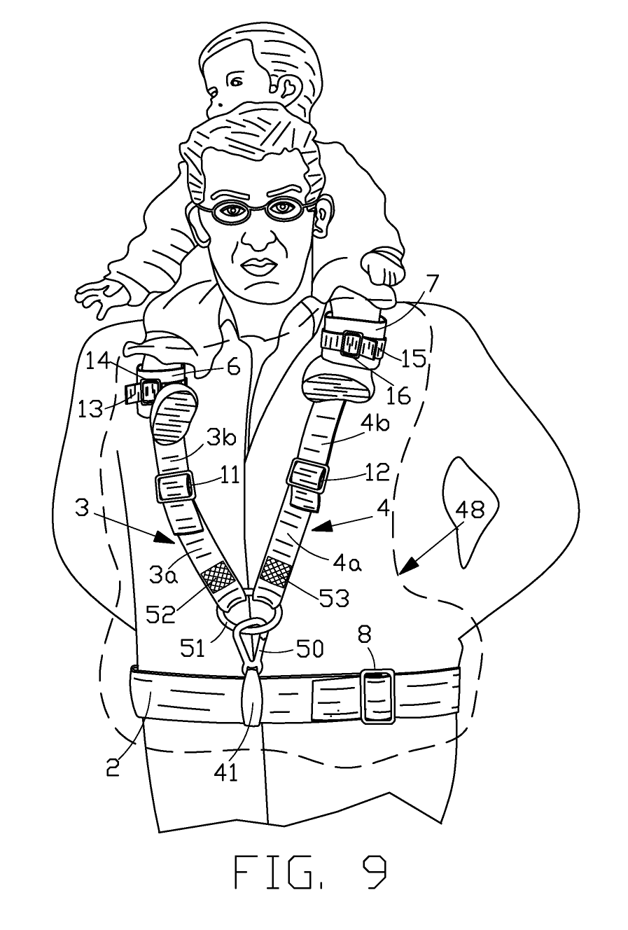

FIG. 9 shows a harness 48 that differs from the preceding harness 40 because the central support 41 now sustains a hook 50 of the spring-catch type instead of a ring. Hook 50 is pivotal in the seat of the bushing projecting above from the support 41 above the belt 2. Hook 50 closes round a ring 51 held in place by two slots in the ends of sections 3a and 4a by respective areas of stitching 52 and 53. In the case of harness 48 as well, the two chest straps 3 and 4 lie V-shaped.

FIG. 10 shows another version of the belt 2 in FIG. 8 again differing due to the presence of two further supports, 56 and 58, for two rings, 57 and 59. The two supports, 56 and 58, are fixed one at each side of support 41 and close to it. In this version both spring-catches 43 and 44 can be hooked to the central ring 42, with the two chest straps 2 and 3 assuming a V-shape, or be separately hooked to the lateral rings, 57 and 59, in which case the chest straps 2 and 3 will lie straight.

It will be clear from the above description that the various types of harness are more or less modular, namely are made of several component parts. To use the harness, the adult should first of all assemble it and then fit the ankle bands 6 and 7 on the child's legs and moderately tighten the small straps 13 and 15 using the buckles 14 and 16. The child can then be lifted onto the shoulders of the adult who closes the buckle of belt 2, tightening it as required and adjusting the length of the chest straps 3 and 4. To lift the child down again, it is only necessary first to undo the buckle on belt 2 and then to undo the small straps 13 and 15.

Based on the description given of realization of a preferred example, it is clear that some changes may be made to it by an expert in the field without thereby departing from the sphere of the invention, as will appear from the following claims.

1-10. (canceled)

11. A harness (1, 33, 40, 48) for children carried on the shoulders of adults, comprising:
two bands (6, 7) to fit round the ankles of the child, with padding on the inside;
means for closing the ankle bands (13, 14; 15, 16);
a belt (2) of adjustable length to be worn round the trunk of the adult situated at groin level, fitted with at least one buckle (5, 8) to close it;
means for connecting the ankle bands (13, 14; 15, 16) to the belt (2);
wherein:
said connecting means include two chest straps (3, 4) of adjustable length, each having a first end stitched to the belt (2) in a first stitched area (9, 10) and a second end stitched to a respective ankle band (6, 7) in a second stitched area (30).

12. The harness according to claim 11, wherein each chest strap (3, 4) consists of two sections (3a, 3b; 4a, 4b) joined by a buckle (11,12) used to fix them at the desired length.

13. The harness according to claim 11, wherein the closing means for each ankle band include a third strap, (13, 15) of adjustable length centrally stitched (30) each to its own ankle band (6, 7) and closable around it by a buckle (14, 16) to adjust the degree of tightness.

14. The harness according to claim 11, wherein the closing means on each ankle band include strips of Velcro at the two ends of each band (6, 7).

15. The harness according to claim 11, wherein said first stitched areas (9, 10) maintain the chest straps (3, 4) substantially orthogonal to the belt (2) one at each side of the closing buckle (5).

16. The harness according to claim 11, wherein said first stitched areas are superimposed or adjacent maintaining the chest straps (3, 4) substantially oblique to the belt (2).
